(19) United States
(12) Patent Application Publication
(10) Pub. No.: US 2025/0356204 A1
(43) Pub. Date: Nov. 20, 2025

(54) LLM REWARD GENERATION FOR ML RISK PREDICTION

(71) Applicant: Ebay Inc., San Jose, CA (US)

(72) Inventors: Bo Qu, Shanghai (CN); Daisuke Yagi, Houston, TX (US); Yang Zhao, Shanghai (CN)

(21) Appl. No.: 18/665,805

(22) Filed: May 16, 2024

(51) Int. Cl. G06N 3/091; G06N 3/092

(52) U.S. Cl. CPC G06N 3/091; G06N 3/092

(57) ABSTRACT

Various examples described herein support or provide operations including providing a prompt to a large language model (LLM) for generating reward functions. The prompt can include a set of instructions for generating a set of reward functions associated with training a reinforcement learning (RL) agent to predict an objective. The set of reward functions is obtained from the LLM and used to train one or more instances of an RL agent to predict the objective. A score representing accuracy of the predicted objective for the one or more instances of the RL agent is generated and an individual instance of the one or more instances of the RL agent is selected to predict the objective based on the generated score.

### TECHNICAL FIELD

The present disclosure generally relates to data processing using machine learning technologies. More particularly, various examples described herein provide for systems, methods, techniques, instruction sequences, and devices that facilitate machine learning model training on risk prediction using a large language model (LLM).

### BACKGROUND

Existing systems face challenges in effectively applying knowledge on past events to detect risky events online. Specifically, current systems leverage machine learning models to generate predictions of risky events online. However, accurately training such machine learning models relies on a well-developed loss function or reward function.

### SUMMARY

In some aspects, the techniques described herein relate to a system including: one or more hardware processors; and at least one machine-storage medium for storing instructions that, when executed by the one or more hardware processors, cause the one or more hardware processors to perform operations including: providing a prompt to a large language model (LLM), the prompt including a set of instructions for generating a set of reward functions associated with training a reinforcement learning (RL) agent to predict an objective; obtaining the set of reward functions from the LLM; training one or more instances of the RL agent using the set of reward functions to predict the objective; generating a score representing accuracy of the predicted objective for the one or more instances of the RL agent; and selecting an individual instance of the one or more instances of the RL agent to predict the objective based on the generated score.

In some aspects, the techniques described herein relate to a system, wherein the objective includes a risk associated with a user in transacting in an item in an electronic marketplace.

In some aspects, the techniques described herein relate to a system, wherein the risk includes a likelihood of unauthorized chargeback associated with the user.

In some aspects, the techniques described herein relate to a system, wherein the RL agent includes a machine learning model that predicts the objective by analyzing a plurality of user features.

In some aspects, the techniques described herein relate to a system, wherein the plurality of user features include at least one of velocity of transactions, type of financial instrument being used by a user, type of device being used by the user, a registration date associated with the user, or collusive behavior information between the user and another user.

In some aspects, the techniques described herein relate to a system, wherein the RL agent includes a multilayer neural network machine learning (ML) model.

In some aspects, the techniques described herein relate to a system, wherein the operations include: concluding a training process of the RL agent in response to determining that the score representing the accuracy of the predicted objective is greater than a threshold value.

In some aspects, the techniques described herein relate to a system, wherein the objective predicted by the individual instance of the one or more instances of the RL agent includes a first likelihood of fraudulent activity before authorizing an electronic transaction, a second likelihood of fraudulent activity after authorizing the electronic transaction, and a third likelihood of fraudulent activity associated with delay capture.

In some aspects, the techniques described herein relate to a system, wherein the operations include removing one or more reward functions from the set of reward functions in response to determining that the one or more reward functions are incapable of accurately training the one or more instances of the RL agent.

In some aspects, the techniques described herein relate to a system, wherein the operations include: training a first instance of the RL agent using a first reward function in the set of reward functions; and training, in parallel with training the first instance, a second instance of the RL agent using a second reward function in the set of reward functions.

In some aspects, the techniques described herein relate to a system, wherein the operations include: applying the first instance of the RL agent to a set of training data to predict a first objective associated with the set of training data; applying the second instances of the RL agent to the set of training data to predict a second objective associated with the set of training data; and evaluating the first and second objectives based on ground truth information of the set of training data to generate a first score and a second score associated respectively with the first and second instances of the RL agent.

In some aspects, the techniques described herein relate to a system, wherein the operations include: determining that the second score is greater than the first score; accessing the second reward function used to train the second instance of the RL agent; and refining the prompt for the LLM using the second reward function.

In some aspects, the techniques described herein relate to a system, wherein the operations include: providing the refined prompt to the LLM with an instruction to generate a revised set of reward functions; and training the one or more instances of the RL agent using the revised set of reward functions provided by the LLM to predict the objective.

In some aspects, the techniques described herein relate to a system, wherein the operations include: comparing accuracy of predicted objectives generated by the one or more instances of the RL agent using the revised set of reward functions with accuracy of the predicted objectives generated using the second reward function; and selectively updating the prompt in response to comparing the accuracy of predicted objectives generated by the one or more instances of the RL agent using the revised set of reward functions with accuracy of the predicted objectives generated using the second reward function.

In some aspects, the techniques described herein relate to a system, wherein the set of instructions include code for the RL agent.

In some aspects, the techniques described herein relate to a system, wherein the set of instructions include an initial reward function.

In some aspects, the techniques described herein relate to a system, wherein a first portion of the set of reward functions includes a revised version of the initial reward function and a second portion of the set of reward functions includes a reward function that is entirely different from the initial reward function.

In some aspects, the techniques described herein relate to a system, wherein the revised version of the initial reward function includes additional penalty terms that are missing from the initial reward function.

In some aspects, the techniques described herein relate to a method including: providing, by one or more processors, a prompt to a large language model (LLM), the prompt including a set of instructions for generating a set of reward functions associated with training a reinforcement learning (RL) agent to predict an objective; obtaining the set of reward functions from the LLM; training one or more instances of the RL agent using the set of reward functions to predict the objective; generating a score representing accuracy of the predicted objective for the one or more instances of the RL agent; and selecting an individual instance of the one or more instances of the RL agent to predict the objective based on the generated score.

In some aspects, the techniques described herein relate to a machine-storage medium for storing instructions that, when executed by one or more hardware processors, cause the one or more hardware processors to perform operations including: providing a prompt to a large language model (LLM), the prompt including a set of instructions for generating a set of reward functions associated with training a reinforcement learning (RL) agent to predict an objective; obtaining the set of reward functions from the LLM; training one or more instances of the RL agent using the set of reward functions to predict the objective; generating a score representing accuracy of the predicted objective for the one or more instances of the RL agent; and selecting an individual instance of the one or more instances of the RL agent to predict the objective based on the generated score.

### BRIEF DESCRIPTION OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some examples are illustrated by way of examples, and not limitations, in the accompanying figures.

FIG. 1 is a block diagram showing an example data system that includes a data management system, according to some examples.

FIG. 2 is a block diagram illustrating an example data management system that facilitates machine learning (ML) model training on risk prediction using a LLM, according to some examples.

FIG. 3 is a flowchart illustrating an example method for facilitating ML model training on risk prediction using an LLM, according to some examples.

FIG. 4 is a diagram illustrating an example architecture for facilitating machine learning model training on risk prediction using an LLM, according to some examples.

FIG. 5 is a flowchart illustrating an example method for facilitating machine learning model training on risk prediction using an LLM, according to some examples.

FIG. 6 are diagrams illustrating example inputs/outputs of the architecture for facilitating ML model training on risk prediction using an LLM, according to some examples.

FIG. 7 is a block diagram illustrating a representative software architecture, which may be used in conjunction with various hardware architectures herein described, according to some examples.

FIG. 8 is a block diagram illustrating components of a machine able to read instructions from a machine storage medium and perform any one or more of the methodologies discussed herein according to some examples.

### DETAILED DESCRIPTION

The description that follows includes systems, methods, techniques, instruction sequences, and computing machine program products that embody illustrative examples of the present disclosure. In the following description, for purposes of explanation, numerous specific details are set forth in order to provide a thorough understanding of examples. It will be evident, however, to one skilled in the art that the present inventive subject matter may be practiced without these specific details.

Reference in the specification to “one example” or “an example” means that a particular feature, structure, or characteristic described in connection with the example is included in at least one example of the present subject matter. Thus, the appearances of the phrase “in one example” or “in an example” appearing in various places throughout the specification are not necessarily all referring to the same example.

For purposes of explanation, specific configurations and details are set forth in order to provide a thorough understanding of the present subject matter. However, it will be apparent to one of ordinary skill in the art that examples of the subject matter described may be practiced without the specific details presented herein, or in various combinations, as described herein. Furthermore, well-known features may be omitted or simplified in order not to obscure the described examples. Various examples may be given throughout this description. These are merely descriptions of specific examples. The scope or meaning of the claims is not limited to the examples given.

Existing systems utilize reinforcement learning (RL) agents to predict likelihood of buyer (or seller) fraud or fraudulent transactions in an electronic marketplace. The accuracy by which the RL agents produce the likelihoods of fraud or risk relies on the design of the reward function used to train the RL agent. Designing a reward function for a RL agent is a critical task that comes with several challenges. The reward function serves as a guiding signal that informs the RL agent about the desirability of its actions within a given environment. The reward function shapes the behavior of the RL agent by reinforcing actions that lead to desired outcomes and discouraging those that do not. However, crafting an effective reward function is far from straightforward and involves careful consideration of the RL agent's objectives, the complexity of the environment, and the potential for unintended consequences.

One of the primary challenges in designing a reward function is ensuring that it accurately reflects the long-term goals of the RL agent. The reward function is tempting to reward short-term gains, but these may not align with the overall objectives. Another challenge is the avoidance of reward hacking, where the RL agent learns to exploit the reward function in ways that were not intended by the designers. This can lead to suboptimal or even harmful behaviors if the RL agent discovers loopholes that yield high rewards without truly satisfying the task's requirements. Moreover, the complexity of the environment can make reward function design particularly challenging. In environments with a vast number of states and actions, it can be difficult to assign rewards that consistently lead to the best outcomes. The designer must anticipate a wide range of scenarios and ensure that the reward function provides clear and appropriate signals in each case. This often involves a significant amount of trial and error, as well as a deep understanding of the environment and the RL agent's capabilities.

Finally, the reward function must be robust to changes in the environment and adaptable to the RL agent's learning progress. As the agent learns and the environment potentially evolves, the reward function may need to be adjusted to continue providing relevant feedback. This dynamic aspect of RL environments adds an additional layer of complexity to the design of the reward function. Engineers spend a great deal of time and effort and multiple rounds of experimentation and iteration accurately designing such reward functions. This time and expense is incredibly inefficient and wastes device resources.

The disclosed examples provide systems, methods, and non-transitory computer-readable media that facilitate ML model training on risk prediction using an LLM. Specifically, the disclosed techniques leverage an LLM to generate the reward function for the RL agent which significantly improves the quality of the reward function and enables the reward function to be designed substantially faster than manually creating reward functions. Also, because the LLM can produce the reward function with fewer iterations and experimentations, the amount of resources used to generate reward functions is reduced which improves the overall efficiencies of the device.

In some examples, the disclosed techniques provide a prompt to an LLM. The prompt can include a set of instructions for generating a set of reward functions associated with training a reinforcement learning (RL) agent to predict an objective (e.g., a level of risk for a buyer in an ecommerce transaction). The disclosed techniques obtain the set of reward functions from the LLM (sequentially or in parallel) and train one or more RL agent instances (sequentially or in parallel) using the set of reward functions to predict the objective. The disclosed techniques generate a score representing accuracy of the predicted objective for the one or more RL agent instances and select an individual RL agent instance to predict the objective based on the generated score.

In some examples, past transaction events can be associated with transactions that are completed (e.g., item delivered, and/or payment processed). Ongoing transaction events can be associated with transactions that are pending (e.g., item to be shipped or delivered, and/or payment to be processed). In some examples, the data management system (or an administrative user of the data management system) can define and/or update the criteria used to qualify a transaction as being completed or pending.

In some aspects, the disclosed techniques provide a prompt to an LLM. The prompt can include a set of instructions for generating a set of reward functions associated with training an RL agent to predict an objective. The disclosed techniques obtain the set of reward functions from the LLM and train one or more instances of an RL agent using the set of reward functions to predict the objective. The disclosed techniques generate a score representing accuracy of the predicted objective for the one or more instances of the RL agent and select an individual instance of the one or more instances of the RL agent to predict the objective based on the generated score.

In some examples, the objective includes a risk associated with a buyer in purchasing an item in an electronic marketplace. In some cases, the risk includes a likelihood of unauthorized chargeback associated with the buyer. In some cases, the RL agent includes a machine learning model that predicts the objective by analyzing a plurality of buyer features. In some examples, the buyer features include at least one of velocity of purchases, type of financial instrument being used by the buyer, type of device being used by the buyer, a registration date associated with the buyer, and/or collusive behavior information between the buyer and a seller.

In some examples, the RL agent includes a multilayer neural network ML model. In some cases, the disclosed techniques conclude a training process of the RL agent in response to determining that the score associated with the accuracy of the predicted objective is greater than a threshold value. In some cases, the objective predicted by the individual instance of the one or more instances of the RL agent includes a first likelihood of fraudulent activity before authorizing an electronic transaction, a second likelihood of fraudulent activity after authorizing the electronic transaction, and a third likelihood of fraudulent activity associated with delay capture.

In some examples, the disclosed techniques remove one or more reward functions from the set of reward functions in response to determining that the one or more reward functions are incapable of accurately training the one or more instances of the RL agent. The disclosed techniques can train a first instance of the RL agent using a first reward function in the set of reward functions and, in parallel with training the first RL agent, train a second instance of the RL agent using a second reward function in the set of reward functions. In some examples, the disclosed techniques apply the first instance of the RL agent to a set of training data to predict a first objective associated with the set of training data. The disclosed techniques apply the second instances of the RL agent to the set of training data to predict a second objective associated with the set of training data and evaluate the first and second objectives based on ground truth information of the set of training data to generate a first score and a second score associated respectively with the first and second instance of the RL agent.

In some examples, the disclosed techniques determine that the second score is greater than the first score. The disclosed techniques access the second reward function used to train the second instances of the RL agent and refine the prompt for the LLM using the second reward function. In some cases, the disclosed techniques provide the refined prompt to the LLM to generate a revised set of reward functions and train the one or more instances of the RL agent using the revised set of reward functions to predict the objective.

In some examples, the disclosed techniques compare accuracy of predicted objectives generated by the one or more instances of the RL agent using the revised set of reward functions with accuracy of the predicted objectives generated using the second reward function. The disclosed techniques selectively update the prompt in response to comparing the accuracy of predicted objectives generated by the one or more instances of the RL agent using the revised set of reward functions with accuracy of the predicted objectives generated using the second reward function.

In some examples, the set of instructions include code for the RL agent. The set of instructions can include an initial reward function. In some cases, a first portion of the set of reward functions includes a revised version of the initial reward function and a second portion of the set of reward functions includes a reward function that is entirely different from the initial reward function. In some cases, the revised version of the initial reward function includes additional penalty terms that are missing from the initial reward function.

Reference will now be made in detail to examples of the present disclosure, examples of which are illustrated in the appended drawings. The present disclosure may, however, be embodied in many different forms and should not be construed as being limited to the examples set forth herein.

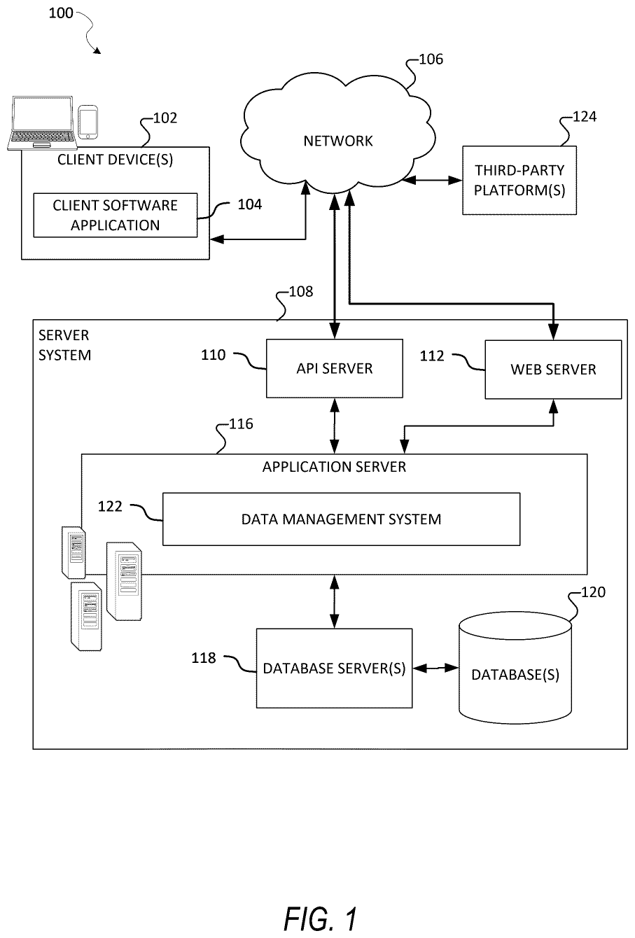

FIG. 1 is a block diagram showing an example data system 100 (or example environment) that includes a data management system 122 (also referred to as system 122), according to various examples. By including the data management system 122, the data system 100 can facilitate ML model training on risk prediction using a set of reward functions generated by an LLM. As shown, the data system 100 includes one or more client devices 102 (or user devices), a server system 108, and a network 106 (e.g., Internet, wide-area-network (WAN), local-area-network (LAN), wireless network) that communicatively couples them together. Each client device 102 can host a number of applications, including a client software application 104. The client software application 104 can communicate data with the server system 108 via a network 106. Accordingly, the client software application 104 can communicate and exchange data with the server system 108 via network 106.

The server system 108 provides server-side functionality via the network 106 to the client software application 104. While certain functions of the data system 100 are described herein as being performed by the data management system 122 on the server system 108, it will be appreciated that the location of certain functionality within the server system 108 is a design choice. For example, it may be technically preferable to initially deploy certain technology and functionality within the server system 108, but to later migrate this technology and functionality to the client software application 104.

The server system 108 supports various services and operations that are provided to the client software application 104 by the data management system 122. Such operations include transmitting data from the data management system 122 to the client software application 104, receiving data from the client software application 104 at the data management system 122, and the data management system 122 processing data generated by the client software application 104. Data exchanges within the data system 100 may be invoked and controlled through operations of software component environments available via one or more endpoints, or functions available via one or more user interfaces of the client software application 104, which may include web-based user interfaces provided by the server system 108 for presentation at the client device 102.

With respect to the server system 108, an Application Program Interface (API) server 110 and a web server 112 is coupled to an application server 116, which hosts the data management system 122. The application server 116 is communicatively coupled to a database server 118, which facilitates access to a database 120 that stores data associated with the application server 116, including data that may be generated or used by the data management system 122.

The API server 110 receives and transmits data (e.g., API calls, commands, requests, responses, and authentication data) between the client device 102 and the application server 116. Specifically, the API server 110 provides a set of interfaces (e.g., routines and protocols) that can be called or queried by the client software application 104 in order to invoke the functionality of the application server 116. The API server 110 exposes various functions supported by the application server 116 including, without limitation, user registration; login functionality; data object operations (e.g., generating, storing, retrieving, encrypting, decrypting, transferring, access rights, licensing); and/or user communications.

The server system 108, or the data management system 122 may extract user data from one or more third-party platforms 124 (e.g., third-party social media platforms). The extracted data may be open-source poster data associated with targeted influencers on the one or more third-party platforms 124 and may include user profile data, activity data, and media posted (either created and/or shared) by the one or more influencers. The media (or media data) include text, image, video, audio, and metadata. Example metadata may include hashtags and labels.

Through one or more web-based interfaces (e.g., web-based user interfaces), the web server 112 can support various functionality of the data management system 122 of the application server 116.

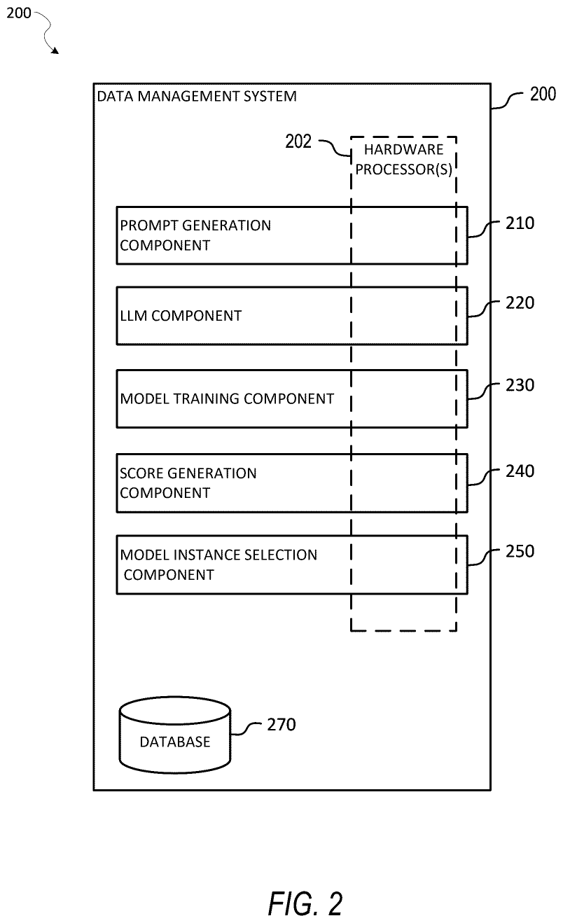

FIG. 2 is a block diagram illustrating an example data management system 200 that facilitates ML model training on risk prediction, according to various examples. For some examples, the data management system 200 represents an example of the data management system 122 described with respect to FIG. 1. As shown, the data management system 200 includes a prompt generation component 210, an LLM component 220, a model training component 230, a score generation component 240, and a model instance selection component 250. According to various examples, one or more of the prompt generation component 210, the LLM component 220, the model training component 230, the score generation component 240, and the model instance selection component 250 are implemented by one or more hardware processors 202. Data generated by one or more of the prompt generation component 210, the LLM component 220, the model training component 230, the score generation component 240, and the model instance selection component 250 may be stored in a database (or datastore) 270 of the data management system 200.

The prompt generation component 210 can receive input that defines a prompt for an LLM to generate a set of reward functions. The reward functions can be used to train an RL agent to predict an objective. The objective predicted by the individual instance of the one or more instances of the RL agent include a first likelihood of fraudulent activity before authorizing an electronic transaction, a second likelihood of fraudulent activity after authorizing the electronic transaction, and/or a third likelihood of fraudulent activity associated with delay capture. For example, the RL agent can include one or more ML models that analyze features (e.g., user features of one or more user profiles in an electronic marketplace) and generate a likelihood of risk of fraud associated with the features or user. The user features can include any combination of velocity of transactions, type of financial instrument being used by the user, type of device being used by the user, a registration date associated with the user, or collusive behavior information between the user and another user.

The prompt can include one or more instructions that instruct the LLM to generate a plurality of reward functions. In some examples, the prompt can include any number of different parameters. For example, the prompt can include a description of the task the LLM is instructed to solve or perform. The prompt can include some or all portions of the code that implements the RL agent or the training code and other ML or neural network code. The prompt can also include an example of a reward function that is the target or objective of the LLM to improve and/or a list of examples of reward functions previously used to train the RL agent to perform the objective. The task can instruct the LLM to use the inputs of the prompt to improve one or more of the reward functions that are included in the prompt and/or generate an entirely new reward function. The LLM can be instructed to output multiple reward functions, some of which can be an improved version of the example reward functions that are included in the prompt and others can include entirely new reward functions generated by the LLM.

The prompt generation component 210 can provide the prompt to the LLM component 220. The LLM component 220 can implement and/or access an LLM. LLMs are sophisticated artificial intelligence systems designed to understand, interpret, and generate human language. These models are considered “large” due to their extensive neural network architectures and the substantial datasets they are trained on. As a subset of transformer models, LLMs excel in natural language processing tasks by recognizing patterns and structures in text data through unsupervised learning. This enables them to perform complex language tasks such as translation, summarization, and text generation with a high degree of proficiency. In the context of RL, LLMs can play a role in developing reward functions, which are crucial for guiding the behavior of RL agents. An RL agent learns by interacting with its environment, aiming to maximize cumulative rewards over time. The reward function instructs the RL agent on what objectives to pursue, influencing its decision-making process.

The LLM component 220 can implement one or more LLMs that can contribute to the generation of reward functions for the RL agent in various ways. The LLM component 220 can parse and convert natural language descriptions of tasks (provided by the prompt generation component 210) into formal reward functions that the RL agent can interpret. For example, the LLM component 220 can take a user's description of a task, such as detecting fraud in electronic commerce transactions, and create a reward function that incentivizes the desired behavior. The LLM component 220 can output any number of reward functions sequentially or in parallel in a single iteration.

The LLM component 220 provides the reward functions to the model training component 230. The model training component 230 can implement one or more RL agents. In some cases, the model training component 230 implements a single RL agent that is trained to predict fraud in electronic commerce transactions. The model training component 230 can implement multiple instances (copies) of the single RL agent and can, in parallel, feed the same training data (or different sets of training data) to each instance of the RL agent but with different ones of the reward functions received from the LLM component 220. The model training component 230 can analyze the multiple reward functions received from the LLM component 220 to ensure they are compatible with the RL agent implemented by the model training component 230. The model training component 230 can remove or delete or omit an individual reward function from the set of reward functions in response to determining that the individual reward function is incompatible with the RL agent. The model training component 230 can generate a filtered set of reward functions in response to removing one or more reward functions from the set of reward functions received from the LLM component 220 that have been determined to be incompatible with the RL agent.

In some examples, the model training component 230 can provide a first reward function from the filtered set of reward functions received from the LLM component 220 to a first instance of the RL agent and can train that first instance of the RL agent using the training data and the first reward function. After training the first instance of the RL agent based on the first reward function (or in parallel with training of the first instance), the model training component 230 can provide a second reward function from the filtered set of reward functions received from the LLM component 220 to a second instance of the RL agent and can train that second instance of the RL agent using the training data and the second reward function.

The model training component 230 can generate outputs using the different instances of the RL agent that were trained using the different reward functions. Specifically, the multiple trained RL agent instances are provided to the score generation component 240. The score generation component 240 can input various sample datasets (that include ground truth information about risk likelihoods in electronic marketplace transactions) to each instance of the RL agent to generate respective evaluations of the instances of the RL agents. The evaluations can include scores representing performance of each RL agent instance. In some cases, a first evaluation is associated or generated for a first RL agent and is stored in association with the first reward function used to train the first RL agent. A second evaluation is associated or generated for a second RL agent and is stored in association with the second reward function used to train the second RL agent.

The evaluations and/or scores are provided by the score generation component 240 to the model instance selection component 250. The model instance selection component 250 can analyze the evaluations and select one or more reward functions that were used to train respective RL agent instances that resulted in performance or score that transgressed a threshold score. For example, the model instance selection component 250 can determine that a third RL agent instance, trained using a third reward function, produced results or was evaluated to have a score that transgressed the threshold score. In some cases, the model instance selection component 250 can also determine that the second RL agent instance is also associated with a score that transgressed the threshold score but that the first RL agent instance is associated with a score that fails to transgress the threshold score. In such cases, the model instance selection component 250 provides the reward functions used to train the RL agent instances that are associated with scores that transgressed the threshold score to the prompt generation component 210.

The prompt generation component 210 can generate a revised prompt for the LLM component 220 based on the reward functions identified or selected by the model instance selection component 250. The prompt generation component 210 can update the instructions to the LLM to include the identified reward functions with an instruction for the LLM to further improve the identified reward functions. In a second iteration, the LLM component 220 can generate another set of reward functions that are then provided to the score generation component 240 for training and evaluation of the RL agent instances. In some cases, the model instance selection component 250 can determine that evaluations or scores transgress a stopping threshold. In such cases, the model instance selection component 250 avoids having the LLM component 220 generate new reward functions and outputs the corresponding RL agent instance that was trained to produce the score that transgressed the stopping threshold for implementation in the system. The RL agent instance that is output can be used to generate real-time predictions on fraudulent transactions in an electronic marketplace.

Below is an example pseudo-code that can be implemented by the data management system 200 to generate the multiple reward functions by the LLM and evaluate the reward functions. In the below example, Niter is a variable that controls the number of iterations of the LLM generating multiple reward functions, Nₛₐₘₚₗₑₛ represents the number of reward functions generated by the LLM, N_{episodes} represents a maximum number of instances of the RL agent that are trained using respective reward functions, θ_{recall}, R_{scores} are parameters used to evaluate performance of each RL agent (e.g., neural network), M_{b} is the baseline model against which each RL agent instance is compared, Aⱼ corresponds to each instances of the RL agent, f_{best} represents the current reward function that is selected as the best performing reward function. SampleRewardFunction is a function or operation that provides a prompt to an LLM to generate a set of reward functions, ValidateStructure is a function or operation that verifies whether a given reward function is compatible with the RL agent, TrainAgent is a function or operation used to train the RL agent instance (e.g., neural network), EvaluateAgent is a function or operation that generates a score, feedback or performance criteria for a given RL agent instance that has been trained, FindBestRewardFunction is a function or operation that compares performances and feedback of each RL instance to identify one or more that are best performing, UpdateLLMInput is a function or operation that modifies the prompt provided to the LLM to generate additional reward functions.

Algorithm 1
LLM-based Reward Function Optimization for Reinforcement
Learning Agent

Require: Nᵢₜₑᵣ, Nₛₐₘₚₗₑₛ, N_{episode}s, θ_{recall}, R_{scores}

| | |
|---|---|
| 1: | Initialize environment E, baseline model [symbol] , and evaluation |

parameters

| | |
|---|---|
| 2. | f_{best} ← InitializeBestRewardFunction( ) |
| 3. | for i = 1 to Nᵢₜₑᵣ do |
| 4: | for j = 1 to Nₛₐₘₚₗₑₛ do |
| 5. | ${f}_{reward}^{j} ← SampleRewardFunction ( ℒℒℳ )$ |
| 6. | ${ValidateStructuref}_{reward}^{j}$ |
| 7. | end for |
| 8. | Initialize feedback and success lists: feedbacks, success |
| 9. | $for each {f}_{reward}^{j} do$ |
| 10. | ${𝒜}_{j} ← TrainAgent ( ε , {f}_{reward}^{j} \cdot {N}_{episodes} )$ |
| 11. | feedback, success ;< EvaluateAgent( [symbol] , [symbol] , θ_{recall}, R_{scores}) |
| 12. | Append _{feedbackj} to feedbacks and successⱼ to success |
| 13. | end for |
| 14. | fbest ←best_index←FindBestRewardFunction(feedbacks, success, |

f_{best})

| | |
|---|---|
| 15. | if f_{best} is updated then |
| 16. | UpdateLLMInput(feedbacks;best_index]) |
| 17. | else if sub-optimal reward function found then |
| 18. | UpdateLLMInput with sub-optimal reward feedback |
| 19. | else |
| 20. | Let LLM summarize reflections based on the failed reward |

functions information and include its experience into the instructions
for the next iteration

| | |
|---|---|
| 21. | end if |
| 22. | end for |

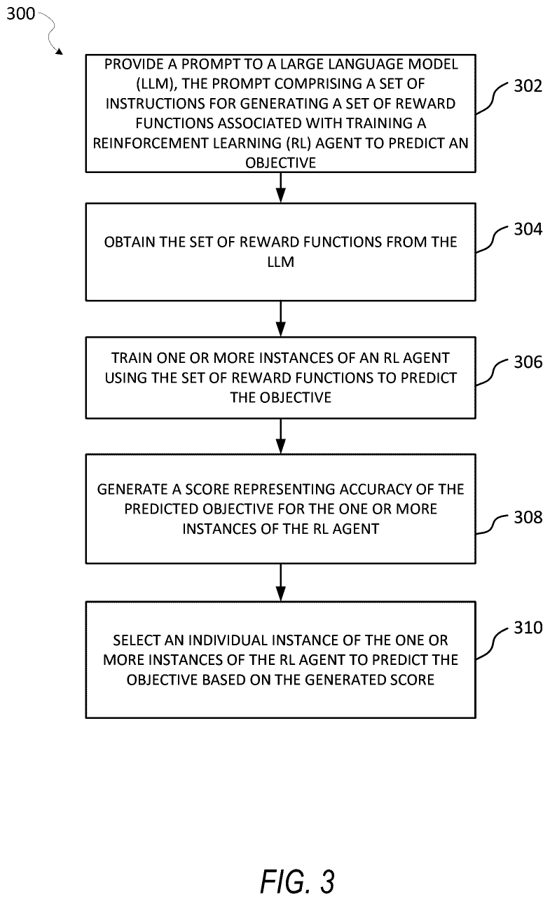

FIG. 3 is a flowchart illustrating an example method 300 for facilitating machine learning model training on risk prediction, according to some examples. It will be understood that example methods described herein may be performed by a machine in accordance with some examples. For example, method 300 can be performed by the data management system 122 described with respect to FIG. 1, the data management system 200 described with respect to FIG. 2, or individual components thereof. An operation of various methods described herein may be performed by one or more hardware processors (e.g., central processing units or graphics processing units) of a computing device (e.g., a desktop, server, laptop, mobile phone, tablet, etc.), which may be part of a computing system based on a cloud architecture. Example methods described herein may also be implemented in the form of executable instructions stored on a machine-readable medium or in the form of electronic circuitry. For instance, the operations of method 300 may be represented by executable instructions that, when executed by a processor of a computing device, cause the computing device to perform method 300. Depending on the example, an operation of an example method described herein may be repeated in different ways or involve intervening operations not shown. Though the operations of example methods may be depicted and described in a certain order, the order in which the operations are performed may vary among examples, including performing certain operations in parallel.

At operation 302, one or more processors provide a prompt to an LLM. The prompt includes a set of instructions for generating a set of reward functions associated with training a RL agent to predict an objective, as discussed above.

At operation 304, one or more processors obtain the set of reward functions from the LLM, as discussed above.

At operation 306, one or more processors train one or more instances of the RL agent using the set of reward functions to predict the objective, as discussed above.

At operation 308, one or more processors generate a score representing accuracy of the predicted objective for the one or more instances of the RL agent, as discussed above.

At operation 310, one or more processors select an individual instance of the one or more instances of the RL agent to predict the objective based on the generated score, as discussed above.

Though not illustrated, method 300 can include an operation where a graphical user interface is displayed (or caused to be displayed) by the hardware processor. For instance, the operation can cause a client device (e.g., the client device 102 communicatively coupled to the data management system 122) to display the graphical user interface (GUI). This operation for displaying the GUI can be separate from operations 302 through 310 or, alternatively, form part of one or more of operations 302 through 310.

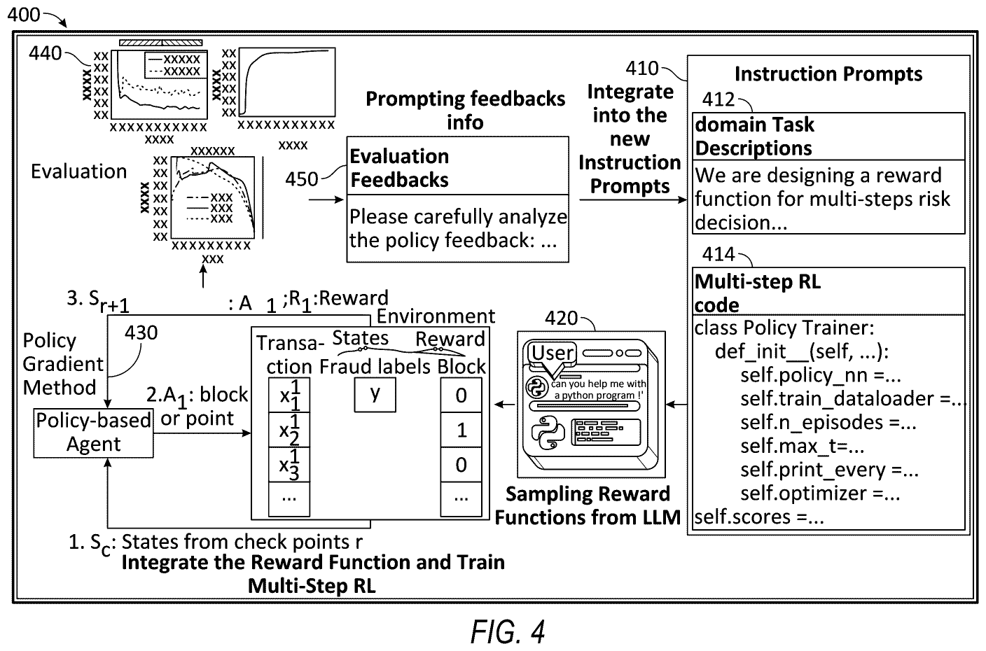

FIG. 4 is a diagram illustrating an example architecture 400 for facilitating ML model training on risk prediction using an LLM, according to some examples. As shown in the architecture 400, a set of instruction prompts 410 can be generated with instructions for an LLM to generate a set of reward functions that can be used to train an RL agent to generate predictions of fraudulent transactions in an electronic marketplace. The set of instruction prompts 410 can include a task portion 412 that specifies the context or task for the LLM to perform and one or more example portions 414. The example portions 414 can include entire code of the RL agent or portions of the code of the RL agent. The one or more example portions 414 can also include one or more examples of reward functions previously used to train the RL agent.

The set of instruction prompts 410 can be processed by the LLM to generate a set of reward functions 420. The set of reward functions 420 can be sampled to exclude or remove any reward function that is incompatible with the code of the RL agent. The set of reward functions 420 can be used to train one or more RL agent instances 430. The trained RL agent instances can then be analyzed or used to process sample training data to generate evaluations 440. In some cases, a first evaluation of the evaluations 440 is associated with a first RL agent instance and/or first reward function and a second evaluation of the evaluations 440 is associated with a second RL agent instance and/or second reward function. The evaluations 440 are analyzed by a feedback component 450 and used to update the set of instruction prompts 410. In another iteration, the set of instruction prompts 410 can be provided to the LLM to generate an updated set of reward functions that are used to again train the RL agent instances. In some cases, the evaluations 440 are analyzed across different iterations. In some examples, a reward function generated by a first iteration can be selected for input to revise the prompt in a second iteration in response to determining that the reward function produced or is associated with a higher evaluation or score than any given reward function used in the second iteration to train the RL agent instances.

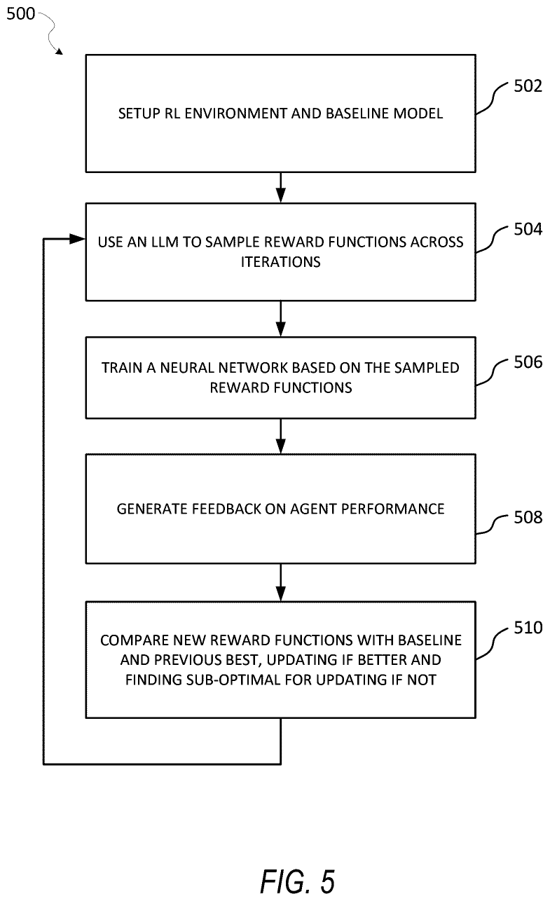

FIG. 5 is a flowchart illustrating an example method 500 for facilitating machine learning model training on risk prediction, according to some examples. It will be understood that example methods described herein may be performed by a machine in accordance with some examples. For example, method 500 can be performed by the data management system 122 described with respect to FIG. 1, the data management system 200 described with respect to FIG. 2, or individual components thereof. An operation of various methods described herein may be performed by one or more hardware processors (e.g., central processing units or graphics processing units) of a computing device (e.g., a desktop, server, laptop, mobile phone, tablet, etc.), which may be part of a computing system based on a cloud architecture. Example methods described herein may also be implemented in the form of executable instructions stored on a machine-readable medium or in the form of electronic circuitry. For instance, the operations of method 500 may be represented by executable instructions that, when executed by a processor of a computing device, cause the computing device to perform method 500. Depending on the example, an operation of an example method described herein may be repeated in different ways or involve intervening operations not shown. Though the operations of example methods may be depicted and described in a certain order, the order in which the operations are performed may vary among examples, including performing certain operations in parallel.

At operation 502, one or more processors sets up an RL environment and baseline model for the RL agent (e.g., using an initial set of reward functions). For example, a default RL environment in which a default or baseline RL model is used to process training data to generate predictions and is evaluated on the generated predictions is set up.

At operation 504, one or more processors use an LLM to sample reward functions across iterations. For example, as shown above in connection with Algorithm 1, the LLM receives a prompt and generates multiple reward functions across multiple iterations controlled by the Niter parameter.

At operation 506, one or more processors train a neural network based on the sampled set of reward functions. For example, as shown above in connection with Algorithm 1, multiple RL agent instances (e.g., neural network instances) are trained using respective reward functions.

At operation 508, one or more processors generate feedback on RL agent performance. For example, as shown above in connection with Algorithm 1, the EvaluateAgent is utilized to score and generate feedback representing performance of each RL agent instance and the FindBestRewardFunction is utilized to then select a best performing reward function based on that feedback representing performance.

At operation 510, one or more processors compare new reward functions (e.g., generated by the LLM in a particular iteration) with baseline (e.g., initial reward functions) and previous best reward functions. The one or more processors update the reward function provided in the prompt for the LLM if the new reward functions are better than the baseline and previous best reward functions and find a sub-optimal reward function for updating if not, as discussed above. Specifically, in a particular iteration, a list of reward functions and associated evaluations or scores is generated (e.g., based on the outputs of the RL agent instances trained using the respective reward functions) by the evaluation component. The scores of the functions are compared and the reward function with the highest score is identified as a current best reward function. The score of the best reward function is compared with the score of a previous best or baseline reward function. The previous best reward function can be a reward function generated in a prior iteration of the LLM. If the score is higher, the current best remains as the current reward function having the highest score. If the score is lower than the score of the previous best, the current best reward function is updated to be the previous best reward function. The current best reward function is provided in the prompt with a request for the LLM to update or improve the reward function by generating one or more additional reward functions.

Though not illustrated, method 500 can include an operation where a graphical user interface is displayed (or caused to be displayed) by the hardware processor. For instance, the operation can cause a client device (e.g., the client device 102 communicatively coupled to the data management system 122) to display the graphical user interface (GUI). This operation for displaying the GUI can be separate from operations 502 through 510 or, alternatively, form part of one or more of operations 502 through 510.

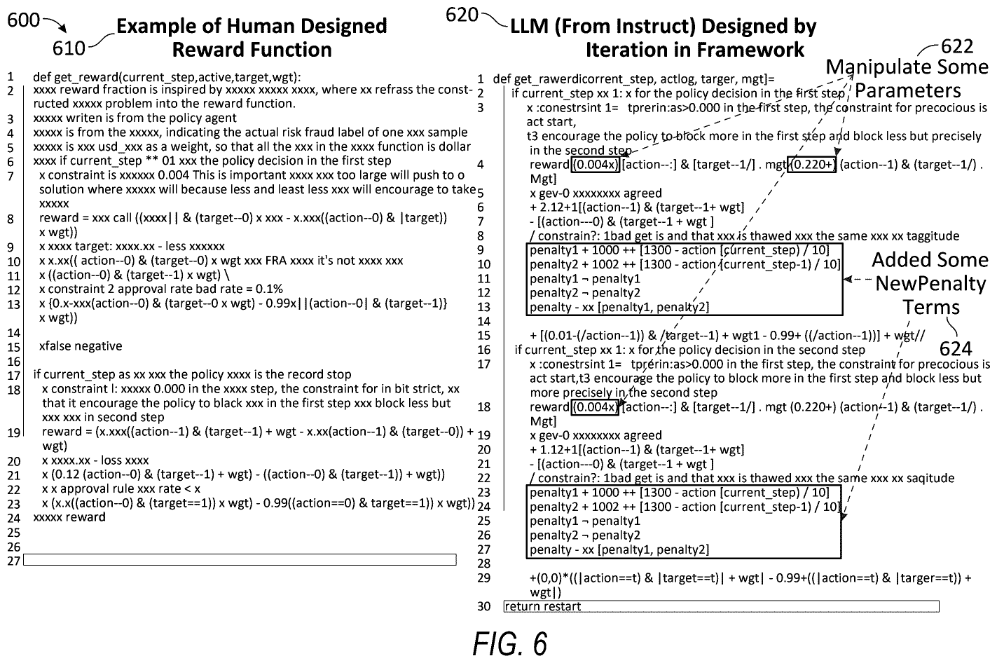

FIG. 6 are diagrams 600 illustrating example inputs/outputs of the architecture for facilitating ML model training on risk prediction using an LLM, according to some examples. For example, as shown in the diagrams 600, the prompt provided to the LLM includes an example of a human generated reward function 610. As one of the outputs of the LLM, an LLM generated reward function 620 is included among a set of reward functions. The LLM generated reward function 620 can include some of the portions of the human generated reward function 610 in which one or more parameters 622 of the human generated reward function 610 are modified or updated. The LLM generated reward function 620 can include one or more new penalty terms 624.

### EXAMPLES

Example 1. A system comprising: one or more hardware processors; and at least one machine-storage medium for storing instructions that, when executed by the one or more hardware processors, cause the one or more hardware processors to perform operations comprising: providing a prompt to a large language model (LLM), the prompt comprising a set of instructions for generating a set of reward functions associated with training a reinforcement learning (RL) agent to predict an objective; obtaining the set of reward functions from the LLM; training one or more instances of the RL agent using the set of reward functions to predict the objective; generating a score representing accuracy of the predicted objective for the one or more instances of the RL agent; and selecting an individual instance of the one or more instances of the RL agent to predict the objective based on the generated score.

Example 2. The system of Example 1, wherein the objective comprises a risk associated with a user in transacting in an item in an electronic marketplace.

Example 3. The system of Example 2, wherein the risk comprises a likelihood of unauthorized chargeback associated with the user.

Example 4. The system of any one of Examples 1-3, wherein the RL agent comprises a machine learning model that predicts the objective by analyzing a plurality of user features.

Example 5. The system of Example 4, wherein the user features comprise at least one of velocity of transactions, type of financial instrument being used by the user, type of device being used by the user, a registration date associated with the user, or collusive behavior information between the user and another user.

Example 6. The system of any one of Examples 1-5, wherein the RL agent comprises a multilayer neural network machine learning (ML) model.

Example 7. The system of any one of Examples 1-6, wherein the operations comprise: concluding a training process of the RL agent in response to determining that the score associated with the accuracy of the predicted objective is greater than a threshold value.

Example 8. The system of any one of Examples 1-7, wherein the objective predicted by the individual instance of the one or more instances of the RL agent comprises a first likelihood of fraudulent activity before authorizing an electronic transaction, a second likelihood of fraudulent activity after authorizing the electronic transaction, and a third likelihood of fraudulent activity associated with delay capture.

Example 9. The system of any one of Examples 1-8, wherein the operations comprise removing one or more reward functions from the set of reward functions in response to determining that the one or more reward functions are incapable of accurately training the one or more instances of the RL agent.

Example 10. The system of any one of Examples 1-9, wherein the operations comprise: training a first instance of the RL agent using a first reward function in the set of reward functions; and training, in parallel with training the first instance, a second instance of the RL agent using a second reward function in the set of reward functions.

Example 11. The system of Example 10, wherein the operations comprise: applying the first instance of the RL agent to a set of training data to predict a first objective associated with the set of training data; applying the second instances of the RL agent to the set of training data to predict a second objective associated with the set of training data; and evaluating the first and second objectives based on ground truth information of the set of training data to generate a first score and a second score associated respectively with the first and second instances of the RL agent.

Example 12. The system of Example 11, wherein the operations comprise: determining that the second score is greater than the first score; accessing the second reward function used to train the second instance of the RL agent; and refining the prompt for the LLM using the second reward function.

Example 13. The system of Example 12, wherein the operations comprise: providing the refined prompt to the LLM with an instruction to generate a revised set of reward functions; and training the one or more instances of the RL agent using the revised set of reward functions provided by the LLM to predict the objective.

Example 14. The system of Example 13, wherein the operations comprise: comparing accuracy of predicted objectives generated by the one or more instances of the RL agent using the revised set of reward functions with accuracy of the predicted objectives generated using the second reward function; and selectively updating the prompt in response to comparing the accuracy of predicted objectives generated by the one or more instances of the RL agent using the revised set of reward functions with accuracy of the predicted objectives generated using the second reward function.

Example 15. The system of any one of Examples 1-14, wherein the set of instructions comprise code for the RL agent.

Example 16. The system of Example 15, wherein the set of instructions comprise an initial reward function.

Example 17. The system of Example 16, wherein a first portion of the set of reward functions comprises a revised version of the initial reward function, a second portion of the set of reward functions comprises a reward function that is entirely different from the initial reward function.

Example 18. The system of Example 17, wherein the revised version of the initial reward function comprises additional penalty terms that are missing from the initial reward function.

Example 19. A method comprising: providing, by one or more processors, a prompt to a large language model (LLM), the prompt comprising a set of instructions for generating a set of reward functions associated with training a reinforcement learning (RL) agent to predict an objective; obtaining the set of reward functions from the LLM; training one or more instances of the RL agent using the set of reward functions to predict the objective; generating a score representing accuracy of the predicted objective for the one or more instances of the RL agent; and selecting an individual instance of the one or more instances of the RL agent to predict the objective based on the generated score.

Example 20. A machine-storage medium for storing instructions that, when executed by one or more hardware processors, cause the one or more hardware processors to perform operations comprising: providing a prompt to a large language model (LLM), the prompt comprising a set of instructions for generating a set of reward functions associated with training a reinforcement learning (RL) agent to predict an objective; obtaining the set of reward functions from the LLM; training one or more instances of the RL agent using the set of reward functions to predict the objective; generating a score representing accuracy of the predicted objective for the one or more instances of the RL agent; and selecting an individual instance of the one or more instances of the RL agent to predict the objective based on the generated score.

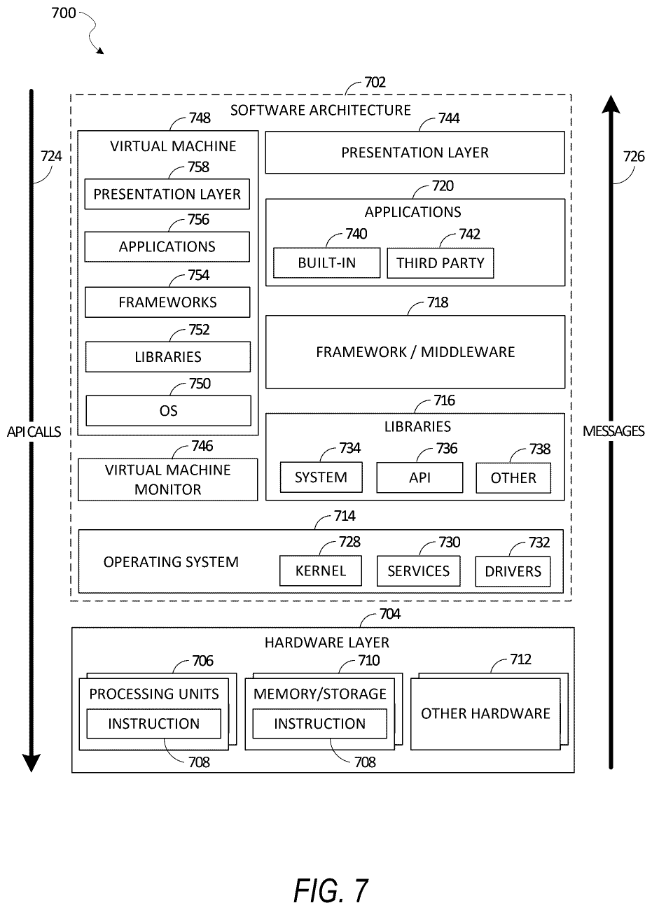

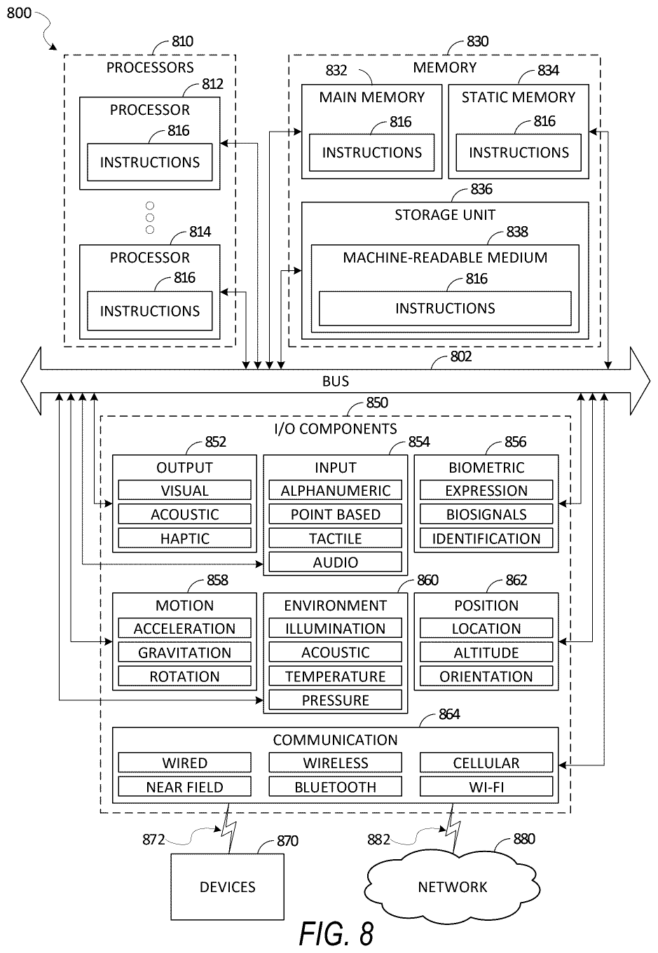

FIG. 7 is a block diagram illustrating an example of a software architecture 702 that may be installed on a machine, according to some examples. FIG. 7 is merely a non-limiting example of a software architecture, and it will be appreciated that many other architectures may be implemented to facilitate the functionality described herein. The software architecture 702 may be executing on hardware such as a machine 800 of FIG. 8 that includes, among other things, processors 810, memory 830, and input/output (I/O) components 850. A representative hardware layer 704 is illustrated and can represent, for example, the machine 800 of FIG. 8. The representative hardware layer 704 comprises one or more processing units 706 having associated executable instructions 708. The executable instructions 708 represent the executable instructions of the software architecture 702. The hardware layer 704 also includes memory or storage modules 710, which also have the executable instructions 708. The hardware layer 704 may also comprise other hardware 712, which represents any other hardware of the hardware layer 704, such as the other hardware illustrated as part of the machine 800.

In the example architecture of FIG. 7, the software architecture 702 may be conceptualized as a stack of layers, where each layer provides particular functionality. For example, the software architecture 702 may include layers such as an operating system 714, libraries 716, frameworks/middleware 718, applications 720, and a presentation layer 744. Operationally, the applications 720 or other components within the layers may invoke API calls 724 through the software stack and receive a response, returned values, and so forth (illustrated as messages 726) in response to the API calls 724. The layers illustrated are representative in nature, and not all software architectures have all layers. For example, some mobile or special-purpose operating systems may not provide a frameworks/middleware 718 layer, while others may provide such a layer. Other software architectures may include additional or different layers.

The operating system 714 may manage hardware resources and provide common services. The operating system 714 may include, for example, a kernel 728, services 730, and drivers 732. The kernel 728 may act as an abstraction layer between the hardware and the other software layers. For example, the kernel 728 may be responsible for memory management, processor management (e.g., scheduling), component management, networking, security settings, and so on. The services 730 may provide other common services for the other software layers. The drivers 732 may be responsible for controlling or interfacing with the underlying hardware. For instance, the drivers 732 may include display drivers, camera drivers, Bluetooth® drivers, flash memory drivers, serial communication drivers (e.g., Universal Serial Bus (USB) drivers), Wi-Fix drivers, audio drivers, power management drivers, and so forth depending on the hardware configuration.

The libraries 716 may provide a common infrastructure that may be utilized by the applications 720 and/or other components and/or layers. The libraries 716 typically provide functionality that allows other software modules to perform tasks in an easier fashion than by interfacing directly with the underlying operating system 714 functionality (e.g., kernel 728, services 730, or drivers 732). The libraries 716 may include system libraries 734 (e.g., C standard library) that may provide functions such as memory allocation functions, string manipulation functions, mathematic functions, and the like. In addition, the libraries 716 may include API libraries 736 such as media libraries (e.g., libraries to support presentation and manipulation of various media formats such as MPEG4, H.264, MP3, AAC, AMR, JPG, and PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 716 may also include a wide variety of other libraries 738 to provide many other APIs to the applications 720 and other software components/modules.

The frameworks/middleware 718 (also sometimes referred to as middleware) may provide a higher-level common infrastructure that may be utilized by the applications 720 or other software components/modules. For example, the frameworks/middleware 718 may provide various graphical user interface functions, high-level resource management, high-level location services, and so forth. The frameworks/middleware 718 may provide a broad spectrum of other APIs that may be utilized by the applications 720 and/or other software components/modules, some of which may be specific to a particular operating system or platform.

The applications 720 include built-in applications 740 and/or third-party applications 742. Examples of representative built-in applications 740 may include, but are not limited to, a home application, a contacts application, a browser application, a book reader application, a location application, a media application, a messaging application, or a game application.

The third-party applications 742 may include any of the built-in applications 740, as well as a broad assortment of other applications. In a specific example, the third-party applications 742 (e.g., an application developed using the Android™ or iOS™ software development kit (SDK) by an entity other than the vendor of the particular platform) may be mobile software running on a mobile operating system such as iOS™, Android™, or other mobile operating systems. In this example, the third-party applications 742 may invoke the API calls 724 provided by the mobile operating system such as the operating system 714 to facilitate functionality described herein.

The applications 720 may utilize built-in operating system functions (e.g., kernel 728, services 730, or drivers 732), libraries (e.g., system libraries 734, API libraries 736, and other libraries 738), or frameworks/middleware 718 to create user interfaces to interact with users of the system. Alternatively, or additionally, in some systems, interactions with a user may occur through a presentation layer, such as the presentation layer 744. In these systems, the application/module “logic” can be separated from the aspects of the application/module that interact with the user.

Some software architectures utilize virtual machines. In the example of FIG. 7, this is illustrated by a virtual machine 748. The virtual machine 748 creates a software environment where applications/modules can execute as if they were executing on a hardware machine (e.g., the machine 800 of FIG. 8). The virtual machine 748 is hosted by a host operating system (e.g., the operating system 714) and typically, although not always, has a virtual machine monitor 746, which manages the operation of the virtual machine 748 as well as the interface with the host operating system (e.g., the operating system 714). A software architecture executes within the virtual machine 748, such as an operating system 750, libraries 752, frameworks 754, applications 756, or a presentation layer 758. These layers of software architecture executing within the virtual machine 748 can be the same as corresponding layers previously described or may be different.

FIG. 8 illustrates a diagrammatic representation of a machine 800 in the form of a computer system within which a set of instructions may be executed for causing the machine 800 to perform any one or more of the methodologies discussed herein, according to an example. Specifically, FIG. 8 shows a diagrammatic representation of the machine 800 in the example form of a computer system, within which instructions 816 (e.g., software, a program, an application, an applet, an app, or other executable code) for causing the machine 800 to perform any one or more of the methodologies discussed herein may be executed. For example, the instructions 816 may cause the machine 800 to execute the methods described above. The instructions 816 transform the general, non-programmed machine 800 into a particular machine 800 programmed to carry out the described and illustrated functions in the manner described. In alternative examples, the machine 800 operates as a standalone device or may be coupled (e.g., networked) to other machines. In a networked deployment, the machine 800 may operate in the capacity of a server machine or a client machine in a server-client network environment, or as a peer machine in a peer-to-peer (or distributed) network environment. The machine 800 may comprise, but not be limited to, a server computer, a client computer, a personal computer (PC), a tablet computer, a laptop computer, a netbook, a personal digital assistant (PDA), an entertainment media system, a cellular telephone, a smart phone, a mobile device, or any machine capable of executing the instructions 816, sequentially or otherwise, that specify actions to be taken by the machine 800. Further, while only a single machine 800 is illustrated, the term “machine” shall also be taken to include a collection of machines 800 that individually or jointly execute the instructions 816 to perform any one or more of the methodologies discussed herein.

The machine 800 may include processors 810, memory 830, and I/O components 850, which may be configured to communicate with each other such as via a bus 802. In an example, the processors 810 (e.g., a hardware processor, such as a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 812 and a processor 814 that may execute the instructions 816. The term “processor” is intended to include multi-core processors that may comprise two or more independent processors (sometimes referred to as “cores”) that may execute instructions contemporaneously. Although FIG. 8 shows multiple processors 810, the machine 800 may include a single processor with a single core, a single processor with multiple cores (e.g., a multi-core processor), multiple processors with a single core, multiple processors with multiples cores, or any combination thereof.

The memory 830 may include a main memory 832, a static memory 834, and a storage unit 836 including machine-readable medium 838, each accessible to the processors 810 such as via the bus 802. The main memory 832, the static memory 834, and the storage unit 836 store the instructions 816 embodying any one or more of the methodologies or functions described herein. The instructions 816 may also reside, completely or partially, within the main memory 832, within the static memory 834, within the storage unit 836, within at least one of the processors 810 (e.g., within the processor's cache memory), or any suitable combination thereof, during execution thereof by the machine 800.

The I/O components 850 may include a wide variety of components to receive input, provide output, produce output, transmit information, exchange information, capture measurements, and so on. The specific I/O components 850 that are included in a particular machine will depend on the type of machine. For example, portable machines such as mobile phones will likely include a touch input device or other such input mechanisms, while a headless server machine will likely not include such a touch input device. It will be appreciated that the I/O components 850 may include many other components that are not shown in FIG. 8. The I/O components 850 are grouped according to functionality merely for simplifying the following discussion, and the grouping is in no way limiting. In some examples, the I/O components 850 may include output components 852 and input components 854. The output components 852 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 854 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further examples, the I/O components 850 may include biometric components 856, motion components 858, environmental components 860, or position components 862, among a wide array of other components. The motion components 858 may include acceleration sensor components (e.g., accelerometer), gravitation sensor components, rotation sensor components (e.g., gyroscope), and so forth. The environmental components 860 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 862 may include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 850 may include communication components 864 operable to couple the machine 800 to a network 880 or devices 870 via a coupling 882 and a coupling 872, respectively. For example, the communication components 864 may include a network interface component or another suitable device to interface with the network 880. In further examples, the communication components 864 may include wired communication components, wireless communication components, cellular communication components, near field communication (NFC) components, Bluetooth® components (e.g., Bluetooth Low Energy), Wi-Fix components, and other communication components to provide communication via other modalities. The devices 870 may be another machine or any of a wide variety of peripheral devices (e.g., a peripheral device coupled via a USB).

Moreover, the communication components 864 may detect identifiers or include components operable to detect identifiers. For example, the communication components 864 may include radio frequency identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 864, such as location via Internet Protocol (IP) geolocation, location via Wi-Fi® signal triangulation, location via detecting an NFC beacon signal that may indicate a particular location, and so forth.

Certain examples are described herein as including logic or a number of components, modules, elements, or mechanisms. Such modules can constitute either software modules (e.g., code embodied on a machine-readable medium or in a transmission signal) or hardware modules. A “hardware module” is a tangible unit capable of performing certain operations and can be configured or arranged in a certain physical manner. In various example examples, one or more computer systems (e.g., a standalone computer system, a client computer system, or a server computer system) or one or more hardware modules of a computer system (e.g., a processor or a group of processors) are configured by software (e.g., an application or application portion) as a hardware module that operates to perform certain operations as described herein.

In some examples, a hardware module is implemented mechanically, electronically, or any suitable combination thereof. For example, a hardware module can include dedicated circuitry or logic that is permanently configured to perform certain operations. For example, a hardware module can be a special-purpose processor, such as a field-programmable gate array (FPGA) or an ASIC. A hardware module may also include programmable logic or circuitry that is temporarily configured by software to perform certain operations. For example, a hardware module can include software encompassed within a general-purpose processor or other programmable processor. It will be appreciated that the decision to implement a hardware module mechanically, in dedicated and permanently configured circuitry, or in temporarily configured circuitry (e.g., configured by software) can be driven by cost and time considerations.

Accordingly, the phrase “module” should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software can accordingly configure a particular processor or processors, for example, to constitute a particular hardware module at one instance of time and to constitute a different hardware module at a different instance of time.

Hardware modules can provide information to, and receive information from, other hardware modules. Accordingly, the described hardware modules can be regarded as being communicatively coupled. Where multiple hardware modules exist contemporaneously, communications can be achieved through signal transmission (e.g., over appropriate circuits and buses) between or among two or more of the hardware modules. In examples in which multiple hardware modules are configured or instantiated at different times, communications between or among such hardware modules may be achieved, for example, through the storage and retrieval of information in memory structures to which the multiple hardware modules have access. For example, one hardware module performs an operation and stores the output of that operation in a memory device to which it is communicatively coupled. A further hardware module can then, at a later time, access the memory device to retrieve and process the stored output. Hardware modules can also initiate communications with input or output devices, and can operate on a resource (e.g., a collection of information).

The various operations of example methods described herein can be performed, at least partially, by one or more processors that are temporarily configured (e.g., by software) or permanently configured to perform the relevant operations. Whether temporarily or permanently configured, such processors constitute processor-implemented modules that operate to perform one or more operations or functions described herein. As used herein, “processor-implemented module” refers to a hardware module implemented using one or more processors.

Similarly, the methods described herein can be at least partially processor-implemented, with a particular processor or processors being an example of hardware. For example, at least some of the operations of a method can be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines 800 including processors 810), with these operations being accessible via a network (e.g., the Internet) and via one or more appropriate interfaces (e.g., an API). In certain examples, for example, a client device may relay or operate in communication with cloud computing systems and may access circuit design information in a cloud environment.

The performance of certain of the operations may be distributed among the processors, not only residing within a single machine 800, but deployed across a number of machines 800. In some example examples, the processors 810 or processor-implemented modules are located in a single geographic location (e.g., within a home environment, an office environment, or a server farm). In other examples, the processors or processor-implemented modules are distributed across a number of geographic locations.

### Executable Instructions and Machine Storage Medium

The various memories (i.e., 830, 832, 834, and/or the memory of the processor(s) 810) and/or the storage unit 836 may store one or more sets of instructions 816 and data structures (e.g., software) embodying or utilized by any one or more of the methodologies or functions described herein. These instructions (e.g., the instructions 816), when executed by the processor(s) 810, cause various operations to implement the disclosed examples.

As used herein, the terms “machine-storage medium,” “device-storage medium,” and “computer-storage medium” mean the same thing and may be used interchangeably. The terms refer to a single or multiple storage devices and/or media (e.g., a centralized or distributed database, and/or associated caches and servers) that store executable instructions 816 and/or data. The terms shall accordingly be taken to include, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

### Transmission Medium

In some examples, one or more portions of the network 880 may be an ad hoc network, an intranet, an extranet, a virtual private network (VPN), a LAN, a wireless LAN (WLAN), a WAN, a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 880 or a portion of the network 880 may include a wireless or cellular network, and the coupling 882 may be a Code Division Multiple Access (CDMA) connection, a Global System for Mobile communications (GSM) connection, or another type of cellular or wireless coupling. In this example, the coupling 882 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data transfer technology.

The instructions may be transmitted or received over the network using a transmission medium via a network interface device (e.g., a network interface component included in the communication components) and utilizing any one of a number of well-known transfer protocols (e.g., hypertext transfer protocol (HTTP)). Similarly, the instructions may be transmitted or received using a transmission medium via the coupling (e.g., a peer-to-peer coupling) to the devices 870. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions for execution by the machine, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

### Computer-Readable Medium

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals. For instance, an example described herein can be implemented using a non-transitory medium (e.g., a non-transitory computer-readable medium).

Throughout this specification, plural instances may implement resources, components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components.

As used herein, the term “or” may be construed in either an inclusive or exclusive sense. The terms “a” or “an” should be read as meaning “at least one,” “one or more,” or the like. The presence of broadening words and phrases such as “one or more,” “at least,” “but not limited to,” or other like phrases in some instances shall not be read to mean that the narrower case is intended or required in instances where such broadening phrases may be absent. Additionally, boundaries between various resources, operations, modules, engines, and data stores are somewhat arbitrary, and particular operations are illustrated in a context of specific illustrative configurations. Other allocations of functionality are envisioned and may fall within a scope of various examples of the present disclosure. The specification and drawings are, accordingly, to be regarded in an illustrative rather than a restrictive sense.

It will be understood that changes and modifications may be made to the disclosed examples without departing from the scope of the present disclosure. These and other changes or modifications are intended to be included within the scope of the present disclosure.

What is claimed is:

1. A system comprising:
one or more hardware processors; and
at least one machine-storage medium for storing instructions that, when executed by the one or more hardware processors, cause the one or more hardware processors to perform operations comprising:
providing a prompt to a large language model (LLM), the prompt comprising a set of instructions for generating a set of reward functions associated with training a reinforcement learning (RL) agent to predict an objective;
obtaining the set of reward functions from the LLM;
training one or more instances of the RL agent using the set of reward functions to predict the objective;
generating a score representing accuracy of the predicted objective for the one or more instances of the RL agent; and
selecting an individual instance of the one or more instances of the RL agent to predict the objective based on the generated score.

2. The system of claim 1, wherein the objective comprises a risk associated with a user in transacting in an item in an electronic marketplace.

3. The system of claim 2, wherein the risk comprises a likelihood of unauthorized chargeback associated with the user.

4. The system of claim 1, wherein the RL agent comprises a machine learning model that predicts the objective by analyzing a plurality of user features.

5. The system of claim 4, wherein the plurality of user features comprises at least one of velocity of transactions, type of financial instrument being used by a user, type of device being used by the user, a registration date associated with the user, or collusive behavior information between the user and another user.

6. The system of claim 1, wherein the RL agent comprises a multilayer neural network machine learning (ML) model.

7. The system of claim 1, wherein the operations comprise:
concluding a training process of the RL agent in response to determining that the score representing the accuracy of the predicted objective is greater than a threshold value.

8. The system of claim 1, wherein the objective predicted by the individual instance of the one or more instances of the RL agent comprises a first likelihood of fraudulent activity before authorizing an electronic transaction, a second likelihood of fraudulent activity after authorizing the electronic transaction, and a third likelihood of fraudulent activity associated with delay capture.

9. The system of claim 1, wherein the operations comprise removing one or more reward functions from the set of reward functions in response to determining that the one or more reward functions are incapable of accurately training the one or more instances of the RL agent.

10. The system of claim 1, wherein the operations comprise:
training a first instance of the RL agent using a first reward function in the set of reward functions; and
training, in parallel with training the first instance, a second instance of the RL agent using a second reward function in the set of reward functions.

11. The system of claim 10, wherein the operations comprise:
applying the first instance of the RL agent to a set of training data to predict a first objective associated with the set of training data;
applying the second instances of the RL agent to the set of training data to predict a second objective associated with the set of training data; and
evaluating the first and second objectives based on ground truth information of the set of training data to generate a first score and a second score associated respectively with the first and second instances of the RL agent.

12. The system of claim 11, wherein the operations comprise:
determining that the second score is greater than the first score;
accessing the second reward function used to train the second instance of the RL agent; and
refining the prompt for the LLM using the second reward function.

13. The system of claim 12, wherein the operations comprise:
providing the refined prompt to the LLM with an instruction to generate a revised set of reward functions; and
training the one or more instances of the RL agent using the revised set of reward functions provided by the LLM to predict the objective.

14. The system of claim 13, wherein the operations comprise:
comparing accuracy of predicted objectives generated by the one or more instances of the RL agent using the revised set of reward functions with accuracy of the predicted objectives generated using the second reward function; and
selectively updating the prompt in response to comparing the accuracy of predicted objectives generated by the one or more instances of the RL agent using the revised set of reward functions with accuracy of the predicted objectives generated using the second reward function.

15. The system of claim 1, wherein the set of instructions comprise code for the RL agent.

16. The system of claim 15, wherein the set of instructions comprise an initial reward function.

17. The system of claim 16, wherein a first portion of the set of reward functions comprises a revised version of the initial reward function and a second portion of the set of reward functions comprises a reward function that is entirely different from the initial reward function.

18. The system of claim 17, wherein the revised version of the initial reward function comprises additional penalty terms that are missing from the initial reward function.

19. A method comprising:
providing, by one or more processors, a prompt to a large language model (LLM), the prompt comprising a set of instructions for generating a set of reward functions associated with training a reinforcement learning (RL) agent to predict an objective;
obtaining the set of reward functions from the LLM;
training one or more instances of the RL agent using the set of reward functions to predict the objective;
generating a score representing accuracy of the predicted objective for the one or more instances of the RL agent; and
selecting an individual instance of the one or more instances of the RL agent to predict the objective based on the generated score.

20. A machine-storage medium for storing instructions that, when executed by one or more hardware processors, cause the one or more hardware processors to perform operations comprising:
providing a prompt to a large language model (LLM), the prompt comprising a set of instructions for generating a set of reward functions associated with training a reinforcement learning (RL) agent to predict an objective;
obtaining the set of reward functions from the LLM;
training one or more instances of the RL agent using the set of reward functions to predict the objective;
generating a score representing accuracy of the predicted objective for the one or more instances of the RL agent; and
selecting an individual instance of the one or more instances of the RL agent to predict the objective based on the generated score.
